(19) United States
(12) Patent Application Publication
(10) Pub. No.: US 2014/0186665 A1
(43) Pub. Date: Jul. 3, 2014

(54) BATTERY SYSTEM

(71) Applicant: MITSUBISHI HEAVY INDUSTRIES, LTD., Tokyo (JP)

(72) Inventor: Akira Takeyama, Tokyo (JP)

(21) Appl. No.: 13/984,930

(22) PCT Filed: Nov. 22, 2012
(86) PCT No.: PCT/JP2012/080345

§ 371 Date: Aug. 12, 2013

(30) Foreign Application Priority Data
Nov. 25, 2011 (JP) 2011-256877

(51) Int. Cl. H01M 10/48

(52) U.S. Cl. CPC H01M 10/48
USPC 429/61

(57) ABSTRACT

A battery system includes a battery cell including a first electrode terminal, a second electrode terminal, and a conductive battery case, a first resistor including a first end which is electrically connected to the first electrode terminal and a second end which is electrically connected to the battery case, a voltmeter, a second resistor, a switch, and a control. When the switch is controlled to be changed from an off state to an on state to electrically connect the second resistor between the first electrode terminal and the second electrode terminal or when the switch is controlled to be changed from the on state to the off state to electrically disconnect the second resistor between the first electrode terminal and the second electrode terminal, the control device monitors a change in the voltage to determine whether the first resistor is electrically connected to the battery case.

### TECHNICAL FIELD

The present invention relates to a battery system that determines the connection state of a pull-up resistor and a pull-down resistor in a battery cell in which the pull-up resistor or the pull-down resistor is connected to a battery case.

Priority is claimed on Japanese Patent Application No. 2011-256877, filed Nov. 25, 2011, the content of which is incorporated herein by reference.

### BACKGROUND ART

A case (hereinafter, referred to as a battery case) which accommodates electrode plates (a positive electrode plate and a negative electrode plate) and an electrolytic solution and forms a battery cell is made of a material which is easy to mold and has strength. In addition, in general, the battery case is made of a metal material with high thermal conductivity (including an alloy, for example, an aluminum alloy) in order to effectively dissipate heat generated from the battery cell due to discharge or charge.

In some cases, the battery case made of the metal material is corroded by a positive electrode active material applied onto the positive electrode plate of the battery cell and a negative electrode active material applied onto the negative electrode plate. As a result, the battery performance deteriorates.

Therefore, a battery has been developed in which a resistor (pull-up resistor) which electrically connects a positive electrode plate and a battery case or a resistor (pull-down resistor) which electrically connects a negative electrode plate and the battery case is arranged in order to make the potential of the battery case equal to the potential of the positive electrode plate or the potential of the negative electrode plate in correspondence with the materials (see Patent Document 1).

### PRIOR ART DOCUMENT

### Patent Document

Patent Document 1: Japanese Unexamined Patent Application, First Publication No. 2008-186591

### SUMMARY OF INVENTION

### Problem to be solved by the Invention

However, although the battery including the pull-up resistor or the pull-down resistor is incorporated into a battery system (for example, an electric vehicle) and is then used, in some cases, by the secular change or the vibration of the battery system, the resistors is physically or electrically disconnected from a predetermined location (hereinafter, referred to as ‘disconnection’).

When the disconnection occurs, the resistor cannot function as the pull-up resistor or the pull-down resistor and, for example, the above-mentioned corrosion occurs. As a result, there is a concern that the battery performance will deteriorate and the battery system will be out of order.

An object of the present invention is to provide a battery system capable of detecting the disconnection of a pull-up resistor or a pull-down resistor with a simple structure.

### Means for Solving the Problem

According to a first aspect of the present invention, a battery system includes a battery cell including a first electrode terminal, a second electrode terminal, and a conductive battery case, a first resistor including a first end which is electrically connected to the first electrode terminal and a second end which is electrically connected to the battery case, a voltmeter that measures a voltage between the second electrode terminal and the second end, a second resistor, a switch that is capable of electrically connecting the second resistor between the first electrode terminal and the second electrode terminal, and a control device that is capable of controlling the switch. When the switch is controlled to be changed from an off state to an on state to electrically connect the second resistor between the first electrode terminal and the second electrode terminal or when the switch is controlled to be changed from the on state to the off state to electrically disconnect the second resistor between the first electrode terminal and the second electrode terminal, the control device monitors a change in the voltage to determine whether the first resistor is electrically connected to the battery case.

According to a second aspect of the present invention, in the battery system according to the first aspect, when the switch is turned on and off, the control device may measure a change in the voltage measured by the voltmeter to determine whether the switch is out of order.

According to a third aspect of the present invention, the battery system according to the first or second aspect may further include a display device that is controlled by the control device. The control device may perform control such that the determination result is displayed on the display device.

According to a fourth aspect of the present invention, in the battery system according to any one of the first to third aspects, the first electrode terminal may be a positive electrode terminal, the second electrode terminal may be a negative electrode terminal, and the first resistor may be a pull-up resistor.

According to a fifth aspect of the present invention, in the battery system according to any one of the first to third aspects, the first electrode terminal may be a negative electrode terminal, the second electrode terminal may be a positive electrode terminal, and the first resistor may be a pull-down resistor.

### Effect of the Invention

According to the battery system of the present invention, it is possible to detect the disconnection of a pull-up resistor or a pull-down resistor with a simple structure.

### BRIEF DESCRIPTION OF DRAWINGS

FIG. 1 is a schematic diagram illustrating a battery system according to an embodiment of the present invention.

FIG. 2 is a detailed circuit diagram illustrating the electrical connection relationship between a battery cell using a pull-up resistor and peripheral structures in the battery system shown in FIG. 1.

FIG. 3A is a diagram illustrating a detection operation of the battery system shown in FIG. 2 and shows a case in which a wiring line is connected to a battery case.

FIG. 3B is a diagram illustrating the detection operation of the battery system shown in FIG. 2 and shows a case in which the wiring line is not connected to the battery case.

FIG. 4 is a detailed circuit diagram illustrating the electrical connection relationship between a battery cell using a pull-down resistor and peripheral structures in the battery system shown in FIG. 1.

### DESCRIPTION OF EMBODIMENTS

One characteristic of a battery system according to an embodiment of the present invention is that the battery system determines and detects whether ‘disconnection’ occurs in a pull-up resistor or a pull-down resistor which is appropriately arranged in a battery cell incorporated into the battery system according to the contents of the battery cell and performs appropriate control and processing.

Hereinafter, the characteristic will be described in detail with reference to the drawings.

The term ‘disconnection’ includes a case in which an electric wire is physically disconnected from a predetermined array and a case in which the electric wire is electrically disconnected such that it cannot conduct electricity.

Next, the battery system according to the embodiment of the invention will be described with reference to the drawings.

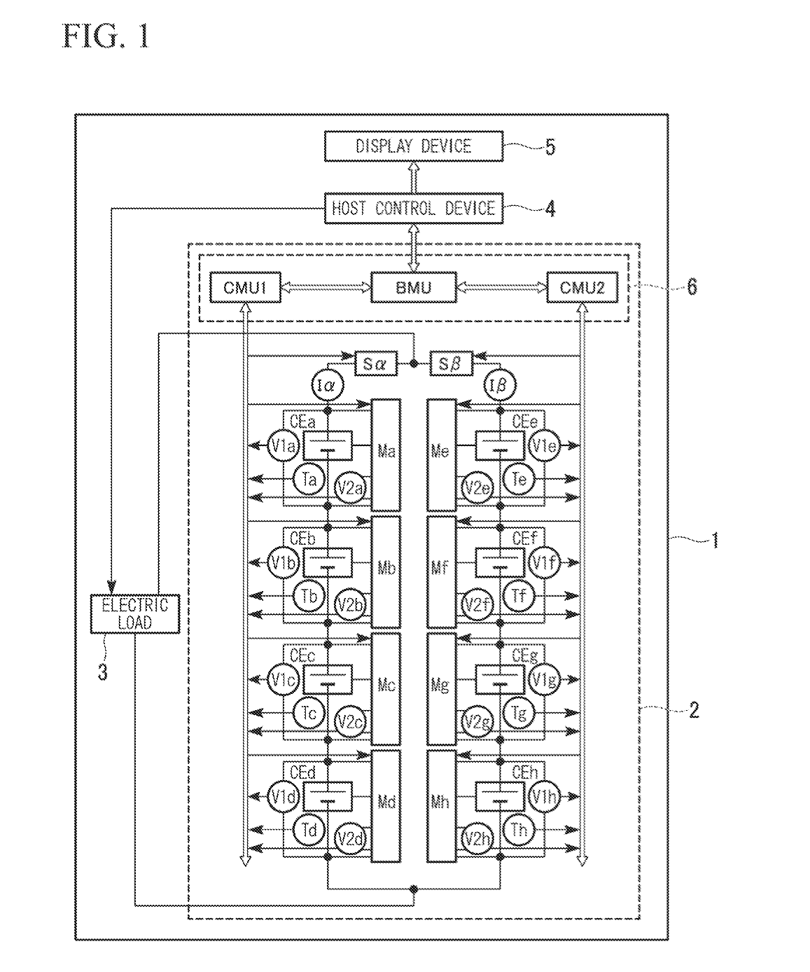

FIG. 1 is a diagram illustrating the structure of a battery system 1.

A battery cell CE used in the battery system 1 can be used in all of a primary battery or a secondary battery, and either a winding type battery, and a lamination type battery for the purpose of use of the battery system 1.

In this embodiment, a chargeable/dischargeable battery cell, for example, a battery cell of a lithium ion secondary battery, which is a storage battery, will be described as an example of the battery cell CE. Specifically, the battery cell CE has a structure in which a conductive battery case is formed by an aluminum alloy. A positive electrode plate and a negative electrode plate are hermetically sealed together with an electrolytic solution in the conductive battery case. In the conductive battery case, the positive electrode plate including a positive electrode active material as lithium manganate and the negative electrode plate including a negative electrode active material as carbon are separated from each other by a separator. A pull-up resistor is provided in the battery cell CE in order to prevent, for example, the corrosion of the battery case.

The battery system 1 includes a battery module 2, an electric load 3, a host control device 4, and a display device 5.

The battery module 2 includes an assembled battery including a plurality of battery cells CE (CEa to CEh) and a BMS (Battery Management System) 6 which is a monitoring control device of the assembled battery. The battery module 2 is inserted into the battery system 1 from the outside of the battery system 1 and is then fixed. Since the battery module 2 is modularized, it can be easily replaced from the outside of the battery system 1.

The electric load 3, the host control device 4, and the display device 5 are incorporated into the battery system 1 in advance. In some cases, the host control device 4 and the BMS 6 are simply referred to as a ‘control device’.

The battery system 1 may be, for example, a moving body, such as an industrial vehicle including a forklift, an electric train, or an electric vehicle in which a wheel is connected to an electric motor, which is the electric load 3, and a moving body, such as an airplane or a ship in which a propeller or a screw is connected to an electric motor, which is the electric load 3. In addition, the battery system 1 may be, for example, a fixed system, such as a home electric power storage system or a power grid stabilization system combined with the generation of natural energy, such as windmill or sunlight. That is, the battery system 1 may be a system which uses at least the discharge of power generated by a plurality of battery cells of the assembled battery or a system which uses the charge and discharge of power.

The assembled battery in the battery module 2 supplies power to the electric load 3 of the battery system 1. In the assembled battery, a first arm including the battery cells CEa to CEd which are connected in series to each other is connected in parallel to a second arm including the battery cells CEe to CEh which are connected in series to each other.

Hereinafter, for components, such as voltage sensors V1 and V2, a temperature sensor T, and a circuit M corresponding to each of the battery cells CEa to CEh, alphabets a to h are appropriately attached to the ends of the reference numerals of the corresponding components to indicate the correspondence between the battery cells and the components.

Temperature sensors Ta to Th for measuring the temperature (hereinafter, referred to as a cell temperature) of the battery case, voltage sensors V1a to V1h for measuring the voltage (hereinafter, referred to as a cell voltage) between the positive electrode terminal and the negative electrode terminal of each battery cell, and voltage sensors V2a to V2h for measuring the voltage (hereinafter, referred to as a case voltage) of the battery case are arranged so as to correspond to the plurality of battery cells CEa to CEh forming the assembled battery.

One of the positive electrode terminal and the negative electrode terminal of each battery cell CE is electrically connected to a battery case C0 to pull up or down the voltage, which will be described below. In addition, the circuits M (Ma to Mh) which perform a known cell balancing process for each battery cell CE are arranged in one-to-one correspondence with the battery cells CE. The circuits M (Ma to Mh) may be mounted on a known circuit board.

The current sensors are arranged in one-to-one correspondence with the arms and can measure a current flowing through each arm. Specifically, a current sensor Iα is arranged so as to correspond to the first arm and a current sensor Iβ is arranged so as to correspond to the second arm.

Arm switches which electrically connect or disconnect each arm to or from the electric load 3 are arranged so as to correspond to each arm. Specifically, an arm switch Sa is arranged so as to correspond to the first arm and an arm switch Sβ is arranged so as to correspond to the second arm.

Measurement information measured and output by various sensors measuring the cell temperature sensor, the cell voltage sensor, the case voltage sensor, and the sensor for measuring current flowing through each arm is input to the BMS 6, which will be described below.

In this embodiment, four battery cells are connected in series to each other to form one arm and a total of two arms are connected in parallel. However, the system may be designed such that one battery cell or two or more battery cells are connected to each arm and one arm or two or more arms are provided.

The BMS 6 includes two cell monitor units (CMUs) and a battery management unit (BMU). The two CMUs are a CMU 1 and a CMU 2.

The CMU 1 and the CMU 2 include analog-digital converters (ADCs) (not shown), receive a plurality of measurement information items which are detected and output by the various sensors as analog signals, and convert the analog signals into corresponding digital signals using the ADCs. Then, the digital signals are output from the CMU 1 and the CMU 2 to the BMU, and wherein the digital signals as a plurality of parameters are used by the BMU to calculate related information (information which is related to the measurement information and includes the charging rate (SOC) of each battery cell calculated by the BMU).

In this embodiment, as shown in FIG. 1, each CMU is connected to the various sensors by a bus or a signal line.

In FIG. 1, for convenience of explanation, the circuits Ma to Mh, the voltage sensors V1a to V1h, and the voltage sensors V2a to V2h are shown separately from the BMS 6. However, in FIG. 1, in practice, the circuits and the voltage sensors are a portion of the BMS 6, particularly, a portion of the corresponding CMU in this embodiment.

The host control device 4 controls the electric load 3 in response to instructions from the user (for example, the amount of depression of an accelerator pedal by the user when the battery system 1 is an electric vehicle). In addition, the host control device 4 receives the related information of the assembled battery transmitted from the BMS 6 and controls the display device 5 such that the related information is appropriately displayed on the display device 5.

When it is determined that the related information is an abnormal value, the host control device 4 turns on a warning lamp provided in the display device 5 and operates a sound device, such as a buzzer provided in the display device 5, to sound an alarm. In this way, the host control device 4 stimulates the visual and auditory senses of the user with light and sound to warn the user.

The display device 5 is, for example, a monitor, such as a liquid crystal panel including the sound device, and can display the related information of each of the plurality of battery cells CEa to CEh forming the assembled battery under the control of the host control device 4.

The electric load 3 is, for example, a power converter such as an electric motor or an inverter connected to the wheel of the electric vehicle. The electric load 3 may be an electric motor which drives, for example, a wiper.

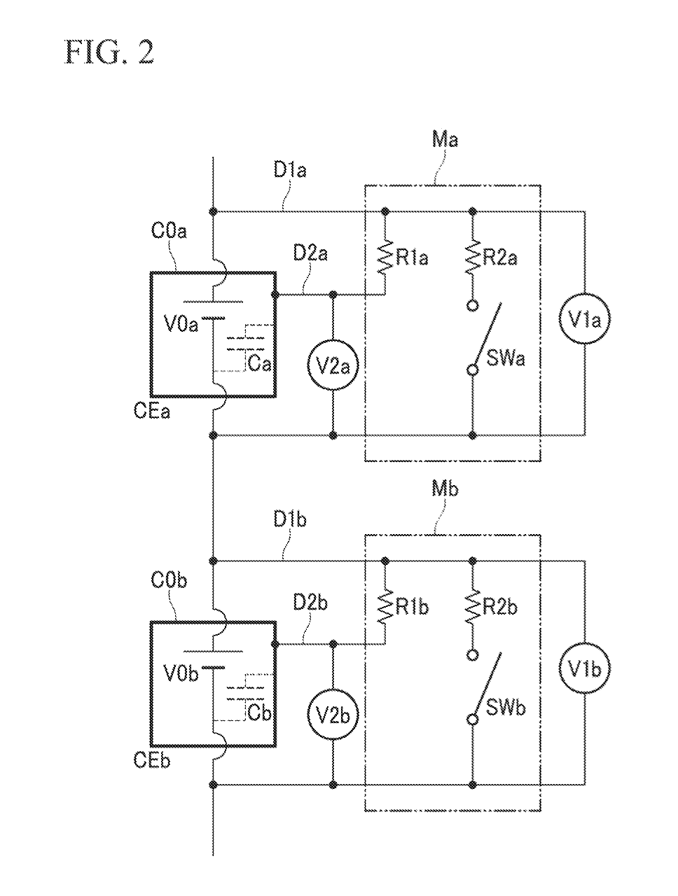

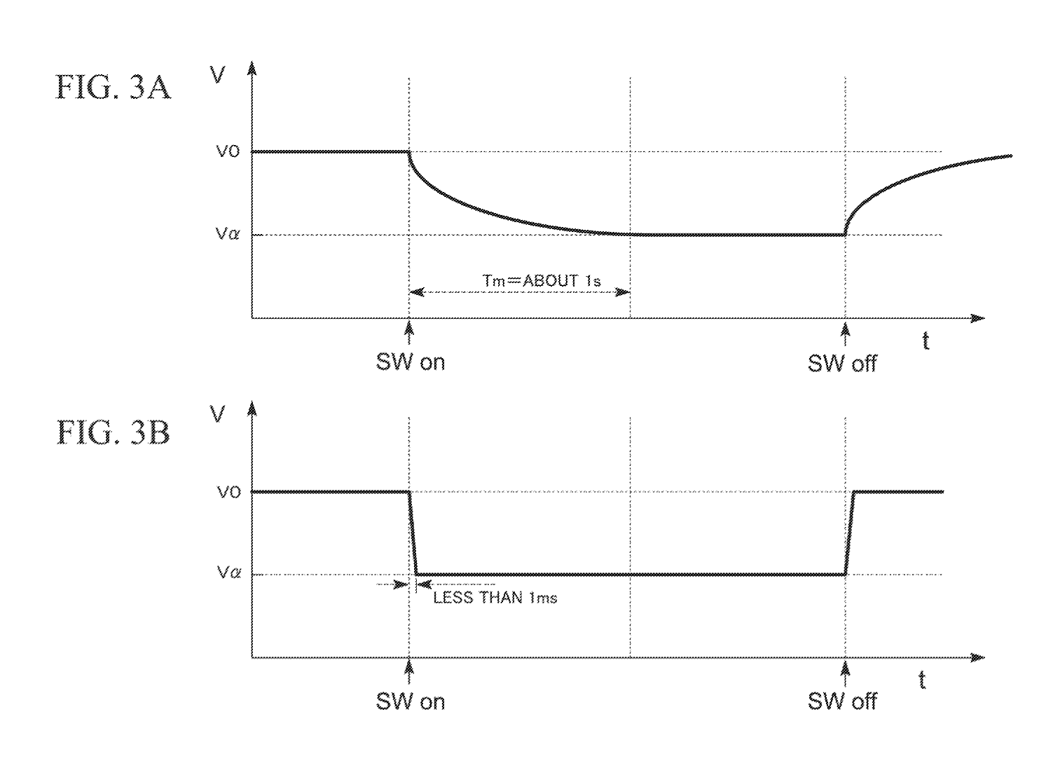

Next, a structure and an operation for controlling a ‘resistor connection determination’ process in each battery cell, which will be described below, in the battery system 1 will be described in detail with reference to FIG. 1, FIG. 2, and FIGS. 3A and 3B.

First, the electrical connection relationship between the components in the vicinity of the battery cell shown in FIG. 1 will be described in detail with reference to FIG. 2. Since the battery cells CE have the same peripheral structure, the peripheral structure of the battery cell CEa in the first arm will be described as a representative example.

Next, a ‘resistor connection determination’ operation will be described with reference to FIG. 1, FIG. 2, and FIGS. 3A and 3B.

The peripheral structure of the battery cell will be described with reference to FIG. 2.

The battery case C0a of the battery cell CEa includes the positive and negative electrode plates which are laminated with the separator interposed therebetween and the electrolytic solution and is hermetically sealed. Therefore, a battery with an electromotive voltage V0a is provided in the battery case C0a. A positive electrode terminal (first electrode terminal) and a negative electrode terminal (second electrode terminal) are formed in the battery case C0a. The positive electrode terminal is electrically connected to the positive electrode plate and the negative electrode terminal is electrically connected to the negative electrode plate in the battery case C0a.

The circuits M (Ma to Mh) have the same structure. The circuit M includes a resistor R1, a resistor R2, and a switch SW which is, for example, a transistor.

When the switch SW is controlled to be turned ‘on’, a first end of the resistor R2 is electrically connected to the positive electrode terminal of the battery cell CE and a second end of the resistor R2 is electrically connected to the negative electrode terminal of the battery cell CE. When the switch SW is controlled to be turned ‘off’, the second end is electrically disconnected from the negative electrode terminal.

In this embodiment, the battery case C0 has substantially the same potential as the positive electrode terminal (the potential of the battery case C0 is ‘pulled up’). Therefore, a ‘first end’ of the resistor R1 (for example, a resistor R1a in the case of the circuit Ma corresponding to the battery cell CEa) is electrically connected to the positive electrode terminal through an electric path D1 (for example, an electric path D1a in the case of the battery cell CEa). A ‘second end’ of the resistor R1 is electrically connected to the battery case C0 (for example, a battery case C0a in the case of the battery cell CEa) through an electric path D2 (for example, an electric path D2a in the case of the battery cell CEa).

The electric path D2 has a resistance value less than that of the resistor R1 and may be formed separately from or integrally with the resistor R1.

The electric path D1 may have the same structure as the electric path D2 and may include the same resistor as the resistor R1. In this case, it is possible to easily perform a second resistor connection determination process, which will be described below.

The voltage sensor V1 (for example, a voltage sensor V1a corresponding to the battery cell CEa) for measuring the cell voltage is arranged and connected so as to measure the voltage between the positive electrode terminal and the negative electrode terminal of the battery cell CE through the electric path D1.

The voltage sensor V2 (for example, a voltage sensor V2a corresponding to the battery cell CEa) for measuring the case voltage is arranged and connected so as to measure the voltage between the negative electrode terminal and the battery case C0 through the electric path D2.

The BMS 6 controls the turning on and off of the switch SW, which will be described below.

In FIG. 2, two electric paths extend from a power line which connects adjacent battery cells CE. However, one electric path common to the battery cells may be provided when it is appropriately controlled.

Next, the operation of the ‘resistor connection determination’ process for each of the battery cells CEa to CEh of the battery system 1 will be described with reference to FIG. 1, FIG. 2, and FIGS. 3A and 3B.

The ‘resistor connection determination’ process is detecting and determining the electrical connection state between the battery case and the pull-up resistor or the pull-down resistor provided in each of the battery cells CEa to CEh. Specifically, it is detected and determined whether the electric path D1 or D2 is disconnected from the battery case C0.

In this embodiment, since the resistor R1 is provided as a pull-up resistor, the ‘resistor connection determination’ process is detecting and determining the electrical connection state between the pull-up resistor and the battery case.

In the battery system 1, the control device (host control device 4) starts the ‘resistor connection determination’ process when the battery system 1 starts.

Next, the procedure of the ‘resistor connection determination’ process will be described.

Before the battery system 1 starts, the switches SWa to SWh of the circuits Ma to Mh are each in an ‘off’ state and the arm switches Sα and Sβ are each in an ‘off’ state.

First, when a start switch of the battery system 1 is turned on (for example, in a case in which the battery system 1 is an electric vehicle, when the user turns on an ignition key), the host control device 4 is supplied with power from a small power supply (not shown) and transmits a determination start signal to the BMS 6 in order to perform the ‘resistor connection determination’ process for each battery cell CE. At that time, various sensors, such as the voltage sensors V1a to V1h and V2a to V2h and the temperature sensors Ta to Th, are supplied with power from the small power supply and start measurement.

One battery cell of the battery module 2 may be used as the small power supply and may supply power for operating the control device. In this case, the battery cell functions as a power supply for supplying power to the electric load 3 as well as a power supply for operating the control device.

When receiving the determination start signal, the BMS 6 acquires the cell voltage of each of the battery cells CEa to CEh as one kind of parameter using the measurement information from the voltage sensors V1a to V1h. In addition, the BMS 6 acquires the case voltage of each of the battery cells CEa to CEh as one kind of parameter using the measurement information from the voltage sensors V2a to V2h.

Then, the BMS 6 performs the ‘first resistor connection determination’ process of determining whether the electric path D1 (hereinafter, referred to as a ‘wiring line D1’ for convenience of explanation) is not disconnected (is electrically connected).

When the wiring line D1 is disconnected, a voltage value indicated by the measurement information from the voltage sensor V1 is different from the value of the electromotive voltage V0 of the corresponding battery cell CE. Therefore, in the first resistor connection determination process, the BMS 6 compares the voltage value indicated by the measurement information from the voltage sensor V1 with the previous value of the cell voltage of the battery cell CE when the start switch is turned off. The previous value of the cell voltage of the battery cell CE when the start switch is turned off is recorded in an electrically rewritable non-volatile memory (EEPROM) (not shown) which is provided in the BMS 6.

When the values are substantially equal to each other, the BMS 6 determines that the wiring line D1 is not disconnected. When the values are substantially different from each other, the BMS 6 determines that the wiring line D1 is disconnected.

For example, when the wiring line D1a is disconnected, the voltage value indicated by the measurement information from the voltage sensor V1a is different from the value of the electromotive voltage V0a of the battery cell CEa. When the previous value of the cell voltage of the battery cell CEa when the start switch is turned off is substantially equal to the current voltage value indicated by the measurement information from the voltage sensor V1a, the BMS 6 determines that the wiring line D1a is not disconnected. When the values are substantially different from each other, the BMS 6 determines that the wiring line D1a is disconnected.

The BMS 6 specifies the battery cell CE (hereinafter, referred to as a first abnormal cell) in which the corresponding wiring line D1 is determined to be cut and electrically disconnected by the first resistor connection determination process among the battery cells CEa to CEh. Then, the BMS 6 performs the ‘second resistor connection determination’ process of determining whether the electric path D2 (hereinafter, referred to as a ‘wiring line D2’ for convenience of explanation) is disconnected for the battery cells CE other than the first abnormal cell.

Since the first abnormal cell has been determined to be abnormal, the second resistor connection determination process is not performed for the first abnormal cell. In other words, the second resistor connection determination process is performed only for the battery cell CE in which the ‘first end’ of the resistor R1 functioning as the pull-up resistor is electrically connected to the positive electrode terminal.

The BMS 6 performs the second resistor connection determination process as follows.

This process is performed for the battery cell CE in which the corresponding wiring line D1 is not disconnected. Therefore, in a steady state, the voltage value indicated by the measurement information from the voltage sensor V2 is substantially equal to the voltage value indicated by the measurement information from the corresponding voltage sensor V1 (the voltage value corresponding to the electromotive voltage V0), regardless of whether the wiring line D2 is disconnected or not.

The BMS 6 detects the influence of the charge or discharge of a capacitor C, which will be described below, using the measurement information from the voltage sensors V1 and V2 in a transient state when the switch SW is controlled to be changed from an ‘off’ state to an ‘on’ state or from the ‘on’ state to the ‘off’ state, thereby determining whether the wiring line D2 is disconnected.

The capacitor C indicates parasitic capacitance generated due to the characteristics of the battery cell, but is not a capacitor which is separately prepared outside the battery cell and is then arranged in the battery cell.

First, the BMS 6 outputs an active switch signal to the circuits Ma to Mh corresponding to each battery cell.

When the active switch signal is input to the circuits Ma to Mh, the switches SWa to SWh of the circuits Ma to Mh are turned ‘on’ and the second ends of the resistors R2 (resistors R2a to R2h) in the circuits Ma to Mh are electrically connected to the corresponding negative electrode terminals. Then, the positive electrode terminal and the negative electrode terminal of the battery cell CE are electrically connected to each other through the resistor R2. Therefore, the measured voltage value of the voltage sensor V1 is dropped from the electromotive voltage V0 by a value corresponding to, for example, the internal resistance of the battery cell CE (not shown) or wiring resistance and becomes a value Vα (hereinafter, referred to as a drop voltage Vα).

In general, the difference between the electromotive voltage V0 and the drop voltage Vα is from about 10 to 40 mV.

However, when a case in which the wiring line D2 is electrically connected to the battery case C0 is compared with a case in which the wiring line D2 is ‘disconnected’ from the battery case C0, there is a large difference in time until the measured value V of the voltage sensor V2 changes to the drop voltage Vα.

When the wiring line D2 is disconnected from the battery case C0, the measured value V rapidly changes to the drop voltage Vα for a time less than 1 ms, as shown in FIGS. 3A and 3B. In contrast, when the wiring line D2 is connected to the battery case C0, the measured value V relatively slowly changes to the drop voltage Vα for a time of several hundreds of microseconds, as shown in FIG. 3A.

The reason is as follows. When the wiring line D2 is connected to the battery case C0, the potential of the battery case C0 of the battery cell CE is substantially equal to the potential of the positive electrode terminal of the battery cell CE. Therefore, the same operation as that when the capacitor which is prepared separately from the battery cell CE is arranged in the battery cell CE occurs between the battery case C0 of the battery cell CE and the negative electrode terminal of the battery cell CE. On the other hand, when the wiring line D2 is not connected to the battery case C0, the operation by the capacitor does not occur. Parasitic capacitance indicating the same operation as that of the capacitor is represented by the capacitor C, as described above.

Therefore, the BMS 6 measures the time t until the measured value V of the voltage sensor V2 changes from approximately V0 to approximately Vα after the active switch signal is output to the BMS 6.

For example, if the time for which the measured value V of the voltage sensor V2 changes from approximately V0 to approximately Vα when the resistor R1 is electrically connected to the battery case C0 of the battery cell CE is a reference time Tm (a sufficiently long time, for example, about one second) and the time t is approximately equal to the reference time Tm, the BMS 6 determines that the ‘second end’ of the resistor R1 is electrically connected to the battery case C0 of the battery cell CE.

On the other hand, when t<<Tm is satisfied, the BMS 6 determines that the wiring line D2 is disconnected and the ‘second end’ is not electrically connected to the battery case C0.

As such, the second resistor connection determination process can determine whether the wiring line D2 is disconnected only by monitoring a change in the measured value V of the voltage sensor V2, without using the voltage sensor V1.

The BMS 6 specifies the battery cell CE (hereinafter, referred to as a second abnormal cell) in which the wiring line D2 is determined to be electrically disconnected from the battery case C0 by the second resistor connection determination process among the battery cells CEa to CEh and outputs an inactive switch signal to the circuits Ma to Mh corresponding to each battery cell. Then, the circuits Ma to Mh receive the inactive switch signal and turn ‘off’ their switches SWa to SWh to electrically disconnect the resistors R2 provided in the circuits Ma to Mh from the battery cases C0. Therefore, the measured value V of the voltage sensor V2 increases to the electromotive voltage V0 of the battery CE as shown in FIGS. 3A and 3B.

In this case, when the wiring line D2 is disconnected, the switch SW is turned ‘off’ and the measured value V of the voltage sensor V2 instantly changes from the drop voltage Vα to the electromotive voltage V0 for a time less than 1 ms, as shown in FIG. 3B. On the other hand, when the wiring line D2 is not disconnected, the measured value V increases relatively slowly, as shown in FIG. 3A.

Therefore, the BMS 6 may determine whether the wiring line D2 is electrically connected to the battery case C0 using this operation, as described in the second resistor connection determination process.

The BMS 6 can determine whether the corresponding switch SW is out of order using the second resistor connection determination process when the measured value V of the voltage sensor V2 does not change as shown in FIGS. 3A and 3B. The BMS 6 can determine and specify which of the switches SWa to SWh corresponding to the battery cells CE to be subjected to the second resistor connection determination process is out of order (for example, the switch which cannot be turned ‘on’ and ‘off’).

Specifically, when the measured value V of the voltage sensor V2 is maintained at V0, the BMS 6 can determine that the switch SW has the trouble that it cannot be turned ‘on’. When the measured value V is not V0, the BMS 6 can determine that the switch SW has the trouble that it cannot be turned ‘off’ or the trouble that it is connected with a given resistance value and is in neither the ‘on’ state nor the ‘off’ state.

The BMS 6 transmits information about the battery cells CE which have been determined to be the first and second abnormal cells and information about the defective switch SW as a portion of the related information of each of the battery cells CEa to CEh to the host control device 4. In addition, the BMS 6 transmits a determination end signal to the host control device 4.

When the related information of each battery cell received by the host control device 4 includes information indicating the first and second abnormal cells or information about the defective switch SW, the host control device 4 determines that an abnormal value is included in the related information and performs, for example, a process of turning on the warning lamp provided in the display device 5. In addition, the host control device 4 displays information indicating the first or second abnormal cell among the battery cells CEa to CEh and information indicating the defective switch SW on the display device 5. In addition, the host control device 4 operates the sound device, such as the buzzer provided in the display device 5, to sound an alarm.

In this way, it is possible to stimulate the visual and auditory senses of the user with light and sound to urge the user to appropriately repair the defective components. In addition, it is possible to specify the battery cell in which the pull-up resistor is electrically disconnected and specify which of the corresponding wiring lines D1 and D2 is disconnected. Therefore, it is easy to repair the defective components. In addition, it is easy to repair the defective switch SW.

When receiving the determination end signal, the host control device 4 activates a first arm switch control signal and transmits the activated first arm switch control signal to the BMS 6, in order to supply the power of the assembled battery to the electric load 3.

When receiving the activated first arm switch control signal, the BMS 6 activates a second arm switch control signal corresponding to the arm without including the first and second abnormal cells or the defective switch SW, in order to change the arm switch Sα or Sβ of the arm without including the first and second abnormal cells or the defective switch SW from an ‘off’ state to an ‘on’ state.

When receiving the activated second arm switch control signal, the arm switch Sα or Sβ changes from the ‘off’ state to the ‘on’ state. On the other hand, at that time, the second arm switch control signal corresponding to the arm including the first and second abnormal cells or the defective switch SW is inactivated. Therefore, the corresponding arm switch is maintained in the ‘off’ state and the arm is not electrically connected to the electric load 3.

Then, of the arms of the battery module 2, the arm without including the first and second abnormal cells or the defective switch SW is electrically connected to the electric load 3. Therefore, when it is determined by the resistor connection determination process that there is no arm including the first and second abnormal cells and the defective switch SW, all of the arms are electrically connected to the electric load 3. Therefore, the battery system 1 can operate (for example, the battery system 1 can travel when it is a moving body such as an electric vehicle).

When there is an arm including the first and second abnormal cells or the defective switch SW, the arm is not connected to the electric load 3, but only the arm without including the first and second abnormal cells or the defective switch SW is connected to the electric load 3. Therefore, for example, when the battery system 1 is a moving body, such as an electric vehicle, it can safely move to at least the repair shop with its own power.

When the start switch is turned off (for example, the user turns off the ignition key), the BMS 6 stores the value of the cell voltage of each battery cell CE in the non-volatile memory and the host control device 4 inactivates the first arm switch control signals corresponding to all arms. Therefore, when receiving the inactivated first arm switch control signal, the BMS 6 inactivates the second arm switch control signals corresponding to all arms in order to change the arm switches Sα and Sβ from an ‘on’ state to an ‘off’ state.

When receiving the inactivated second arm switch control signals, each of the arm switches Sα and Sβ changes from the ‘on’ state to the ‘off’ state. Therefore, the assembled battery of each arm in the battery module 2 is electrically disconnected from the electric load 3.

Then, the supply of power from the small power supply is cut and the measurement operations of the various sensors, such as the voltage sensors V1a to V1h and V2a to V2h and the temperature sensors Ta to Th, are stopped. In addition, the operation of the BMS 6 is stopped. As a result, the operation of the battery system 1 is also stopped.

In the above description, the potential of the battery case C0 is ‘pulled up’. However, the invention is not limited thereto.

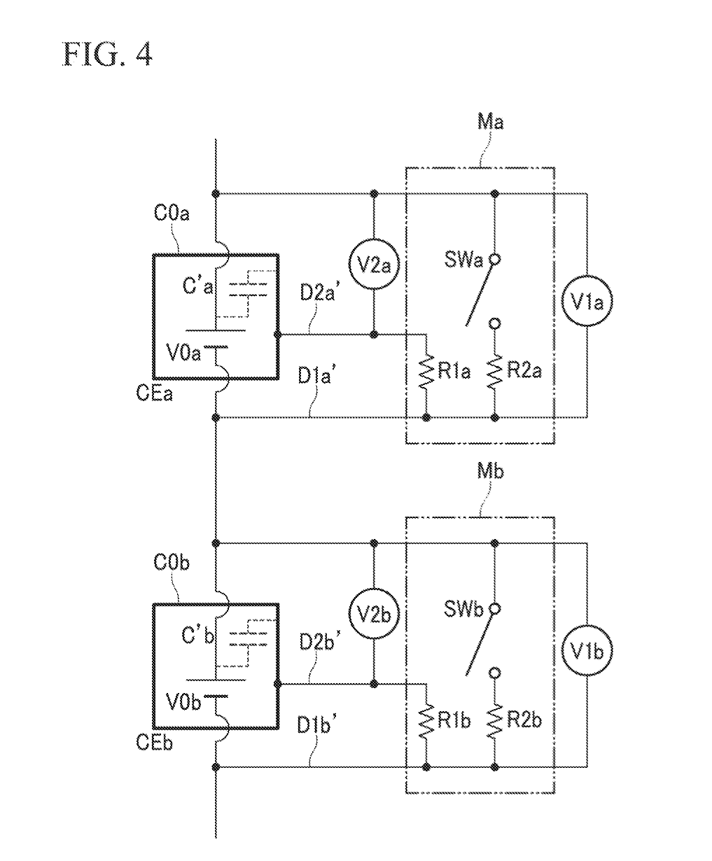

In some cases, the battery case C0 of the battery cell CE is set to substantially the same potential (is ‘pulled down’) as the negative electrode terminal of the battery cell CE, depending on materials, such as the positive electrode active material and the negative electrode active material. In this case, the circuit M shown in FIG. 2 can be used without any change. However, as shown in FIG. 4, the circuit M shown in FIG. 2 which is connected to the battery cell CE is vertically reversed and then connected. That is, in FIG. 4, the position where the circuit M is connected to the positive electrode terminal in FIG. 2 is connected to the negative electrode terminal (first electrode terminal) and the position where the circuit M is connected to the negative electrode terminal in FIG. 2 is connected to the positive electrode terminal (second electrode terminal).

In other words, the ‘first end’ of the resistor R1 is electrically connected to the negative electrode terminal of the battery cell CE through a wiring line D1′ and the ‘second end’ of the resistor R1 is electrically connected to the battery case C0 of the battery cell CE through a wiring line D2′. Therefore, the resistor R1 functions as a pull-down resistor. The voltage sensor V2 for measuring the case voltage is arranged and connected so as to measure the voltage between the positive electrode terminal of the battery cell CE and the battery case C0 of the battery cell CE through the wiring line D2′. According to this structure, a capacitor C′ which is parasitic capacitance corresponding to the capacitor C, is generated between the positive electrode terminal and the battery case.

In this way, a structure for ‘pulling down’ the potential of the battery case C0 is obtained.

In the structure and operation described in the ‘pull-up’ structure, when ‘pull-up’ is replaced with ‘pull-down’, the ‘positive electrode terminal’ is replaced with the ‘negative electrode terminal’, the ‘negative electrode terminal’ is replaced with the ‘positive electrode terminal’, the ‘capacitor C’ is replaced with the ‘capacitor C”, the ‘wiring line D1’ is replaced with the ‘wiring line D1”, and the ‘wiring line D2’ is replaced with the ‘wiring line D2”, the description of a resistor connection determination process in the ‘pull-down’ structure is made. Therefore, the description of the structure for ‘pulling down’ the potential of the battery case C0 will be omitted.

As described above, the circuit M with the same structure can be appropriately used in both the case of pull-up and the case of pull-down. Therefore, it is possible to reduce costs, for example, when the battery system 1 is mass-produced.

The invention is not limited to the above-described embodiment, but various modifications and changes of the invention can be made without departing from the scope and spirit of the invention. For example, the pull-up resistor or the pull-down resistor is not arranged in the circuit board of the circuit M, but may be separately arranged outside the circuit board.

### INDUSTRIAL APPLICABILITY

According to the battery system of the invention, it is possible to detect the disconnection of a pull-up resistor or a pull-down resistor with a simple structure.

### REFERENCE SIGNS LIST

1: BATTERY SYSTEM
2: BATTERY MODULE
3: ELECTRIC LOAD
4: HOST CONTROL DEVICE
5: DISPLAY DEVICE
6: BMS
CE: BATTERY CELL
C0: BATTERY CASE
R1: RESISTOR (FIRST RESISTOR)
R2: RESISTOR (SECOND RESISTOR)
V2: VOLTMETER
SW: SWITCH

1. A battery system comprising:
a battery cell including a first electrode terminal, a second electrode terminal, and a conductive battery case;
a first resistor including a first end which is electrically connected to the first electrode terminal and a second end which is electrically connected to the battery case;
a voltmeter that measures a voltage between the second electrode terminal and the second end;
a second resistor;
a switch that is capable of electrically connecting the second resistor between the first electrode terminal and the second electrode terminal; and
a control device that is capable of controlling the switch,
wherein, when the switch is controlled to be changed from an off state to an on state to electrically connect the second resistor between the first electrode terminal and the second electrode terminal or when the switch is controlled to be changed from the on state to the off state to electrically disconnect the second resistor between the first electrode terminal and the second electrode terminal, the control device monitors a change in the voltage to determine whether the first resistor is electrically connected to the battery case.

2. The battery system according to claim 1,
wherein, when the switch is turned on and off, the control device measures a change in the voltage measured by the voltmeter to determine whether the switch is out of order.

3. The battery system according to claim 1, further comprising:
a display device that is controlled by the control device,
wherein the control device performs control such that the determination result is displayed on the display device.

4. The battery system according to claim 1,
wherein the first electrode terminal is a positive electrode terminal,
the second electrode terminal is a negative electrode terminal, and
the first resistor is a pull-up resistor.

5. The battery system according to claim 1,
wherein the first electrode terminal is a negative electrode terminal,
the second electrode terminal is a positive electrode terminal, and
the first resistor is a pull-down resistor.

6. The battery system according to claim 2, further comprising:
a display device that is controlled by the control device,
wherein the control device performs control such that the determination result is displayed on the display device.

7. The battery system according to claim 2,
wherein the first electrode terminal is a positive electrode terminal,
the second electrode terminal is a negative electrode terminal, and
the first resistor is a pull-up resistor.

8. The battery system according to claim 3,
wherein the first electrode terminal is a positive electrode terminal,
the second electrode terminal is a negative electrode terminal, and
the first resistor is a pull-up resistor.

9. The battery system according to claim 6,
wherein the first electrode terminal is a positive electrode terminal,
the second electrode terminal is a negative electrode terminal, and
the first resistor is a pull-up resistor.

10. The battery system according to claim 2,
wherein the first electrode terminal is a negative electrode terminal,
the second electrode terminal is a positive electrode terminal, and
the first resistor is a pull-down resistor.

11. The battery system according to claim 3,
wherein the first electrode terminal is a negative electrode terminal,
the second electrode terminal is a positive electrode terminal, and
the first resistor is a pull-down resistor.

12. The battery system according to claim 6,
wherein the first electrode terminal is a negative electrode terminal,
the second electrode terminal is a positive electrode terminal, and
the first resistor is a pull-down resistor.
